(19) United States
(12) Patent Application Publication
(10) Pub. No.: US 2019/0136744 A1
(43) Pub. Date: May 9, 2019

(54) ENGINE COOLANT PUMP APPARATUS WITH THREADED CONNECTIONS

(71) Applicant: Ronald LaRochelle, Pottstown, PA (US)

(72) Inventor: Ronald LaRochelle, Pottstown, PA (US)

(21) Appl. No.: 16/127,502

(22) Filed: Sep. 11, 2018

Related U.S. Application Data
(60) Provisional application No. 62/558,193, filed on Sep. 13, 2017.

(51) Int. Cl. F01P 11/04; F01P 5/10; F04B 53/16; F16L 15/08

(52) U.S. Cl. CPC F01P 11/04; F16L 15/08; F04B 53/16; F01P 5/10

(57) ABSTRACT

Described is an apparatus for circulating coolant in the combustion engine of a motor vehicle. This apparatus utilizes a twin volute pump to evenly distribute coolant across an engine block. The pump uses threaded connectors, which allows braided metal hoses to be connected to the pump as opposed to the traditional rubber hoses. This prevents leaks and allows for greater coolant flow and more efficient engine cooling.

### CROSS REFERENCE TO RELATED APPLICATIONS

This Application claims the benefit of U.S. Provisional Application Ser. No. 62/558,193 filed Sep. 13, 2017, the disclosure of which is incorporated by reference herein.

### BACKGROUND

Heat is one of the main by-products of a car's combustion engine. Excess heat can cause significant damage to an engine by causing parts of the engine to crack or expand beyond allowed tolerances. In order to prevent a buildup of excessive heat, most combustion engines employ a radiator and pump system. The pump circulates a fluid, generally engine coolant or water, through a series of tubes in and around the engine block of the engine. The fluid absorbs the excess heat and is then pumped out to a radiator. The fluid then passes through the radiator to cool. After the fluid has cooled, the fluid is then pumped back through the engine block to again absorb the excess heat.

Currently, most radiators and pumps employ rubber hoses to connect to each other and the engine block in order to facilitate the movement of fluid. These radiators and pumps have necks for connecting the hoses to these components and are secured using clamps. That is, each hose usually fits over the necks of the radiator and pump, and a clamp is used to bend the overall circumference of each hose to fit coextensively around the necks of the radiator and pump, respectively.

This system forces vehicle owners to use hoses that are made of materials that degrade and crack over time after exposure to hot fluids. This system also forces car owners to use hoses that are significantly larger than the neck openings but still limit the cross-sectional flow area of the hose to approximately that of the neck.

### SUMMARY

Described is an apparatus for circulating coolant in a combustion engine of a motor vehicle that addresses many of the deficiencies discussed above.

In one embodiment, the apparatus includes a coolant pump, three hoses, and three adapters.

The coolant pump includes two outlet ports and an inlet port. Each of these ports is threaded such that they each can act as a female coupler, meaning that each of them is configured to accept a threaded male adapter.

Accordingly, the apparatus includes three male adapters. Each adapter is configured such that one side of the adapter can be screwed into one of the outlet or inlet ports. The opposite side of each adapter is configured such that it can be screwed into a female coupler on a hose.

The apparatus includes three hoses each connected to one adapter. Each of these hoses has a female coupler on one end that can be screwed onto one end of each adapter. In general, these hoses are composed of braided stainless steel in order to minimize hose degradation and leakage over time.

The apparatus pumps coolant fluid though an internal combustion engine. The hose connected to the inlet port is in turn connected to either a radiator or a coolant reservoir. One of the hoses connected to one of the outlet ports in turn connects to one side of an engine block. The hose connected to the other outlet port connects to the opposing side of the engine block. When the engine reaches a certain temperature, the apparatus pulls coolant from the radiator or coolant reservoir and distributes it to both sides of the engine block. By distributing coolant to both sides of the engine block, the apparatus allows for even cooling across the entire engine block.

In order to pump coolant to both sides of the engine block with only one pumping mechanism, the apparatus utilizes a twin volute housing, meaning that the stream of coolant pulled in through the inlet is split into two even streams that are then pumped out each of the outlets.

The inlet, outlets, adapters, and hoses all use threaded connectors. In one aspect each threaded connector can use a national thread taper (NPT) threading, which allows a fluid-tight seal between the inlet, outlets, adapters, and hoses without using thread sealant.

As discussed above, most radiators and coolant pumps employ rubber hoses with clamps to connect the radiator, the pump and the engine block. Such hose and clamp systems are liable to leak as the hoses crack and degrade with continued exposure to the heat produced by the engine. By using threaded connectors instead of clamps, the apparatus can employ braided metal hoses, which are much less likely to leak than rubber hoses. Threaded connectors also allow the apparatus to use larger hoses than clamps allow. This facilitates greater movement of coolant, which keeps the temperature of the engine lower.

In another embodiment, the female threaded connectors of the inlet and outlets are replaced with male threaded connectors. These male threaded connectors are configured to couple with the female threaded connectors of the hoses, which allows the hoses to connect to the inlet and outlets without using the adapters.

In yet another embodiment, the apparatus only includes one outlet port instead of two. This embodiment does not make use of a twin volute body, because the stream of coolant is not split by the coolant pump. In this embodiment, distribution of coolant through the engine block would be handled by a separate system not disclosed herein.

This summary is provided to introduce a selection of concepts in a simplified form that are further described below. This summary is not necessarily intended to identify key features or essential features of the claimed subject matter, nor is it necessarily intended to be used as an aid in determining the scope of the claimed subject matter.

The foregoing outlines examples of this disclosure so that those skilled in the relevant art may better understand the detailed description that follows. Additional embodiments and details will be described hereinafter. Those skilled in the relevant art should appreciate that they can readily use any of these disclosed embodiments as a basis for designing or modifying other structures or functions for carrying out the invention, without departing from the spirit and scope of the invention.

Reference herein to “one embodiment,” “an embodiment,” “an aspect,” “an implementation,” “an example,” or similar formulations, means that a particular feature, structure, operation, or characteristic described in connection with the embodiment is included in at least one embodiment of the present invention. Thus, different appearances of such phrases or formulations herein do not necessarily refer to the same embodiment. Furthermore, various particular features, structures, operations, or characteristics may be combined in any suitable manner in one or more embodiments.

### BRIEF DESCRIPTION OF THE DRAWINGS

The detailed description is described with reference to the accompanying figures. In the figures, the left-most digit(s) of a reference number identifies the figure in which the reference number first appears. The figures are not necessarily drawn to scale.

FIG. 1 shows a top view of an embodiment of a motor vehicle coolant circulation apparatus including a coolant pump, three hoses, and three adapters.

FIG. 2 shows a top view of a cutaway portion of a coolant pump inlet and an adapter.

FIG. 3 shows an isometric view of a coolant pump with an adapter.

FIG. 4 shows an embodiment of a motor vehicle coolant circulation apparatus connected to an engine block.

FIG. 5 shows a top view of a portion of another embodiment of a motor vehicle coolant circulation apparatus.

### DETAILED DESCRIPTION

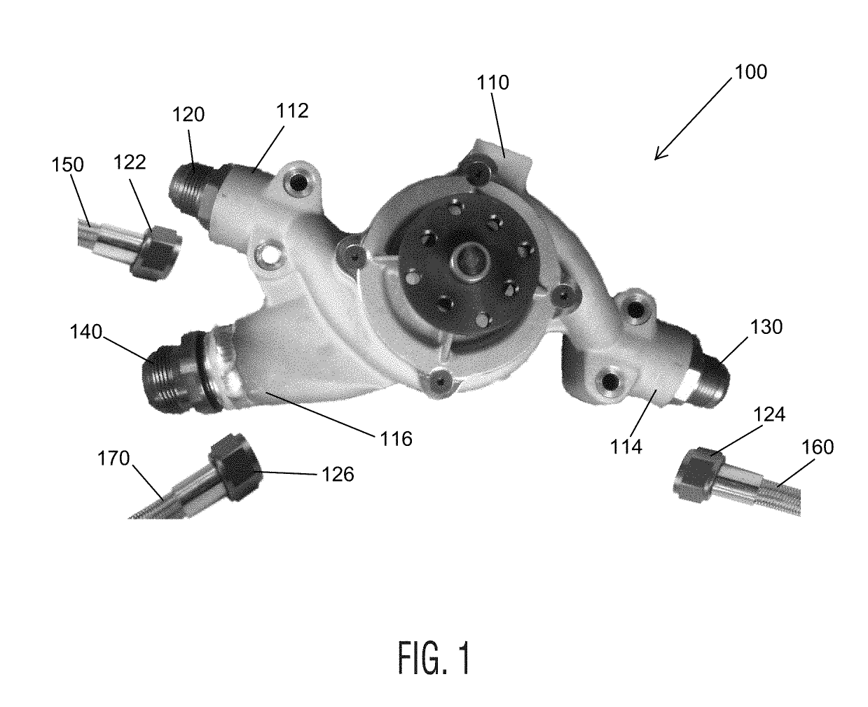

Described is an apparatus for circulating coolant in a combustion engine of a motor vehicle. Some embodiments of the apparatus may be described with reference to FIGS. 1 through 5.

FIG. 1 shows a top view of an embodiment of the apparatus 100. Apparatus 100 may include a coolant pump 110, a first adapter 120, a second adapter 130, a third adapter 140, a first hose 150, a second hose 160, and a third hose 170.

### Pump

As shown in FIG. 1, pump 110 includes a first outlet port 112, a second outlet port 114, and an inlet port 116.

Pump 110 moves coolant from a reservoir or radiator to an engine block (not seen in FIG. 1). Coolant enters pump 110 from a reservoir or radiator through port 116 and exits pump 110 to an engine block through port 112 and port 114. Coolant flows to one side of the engine block through port 112 and flows to the opposite side of the engine block through port 114.

In order to pump coolant to both sides of an engine block with only one pumping mechanism, pump 110 has a twin volute housing, meaning that the stream of coolant pulled in through port 116 is split into two even streams that are then pumped out of port 112 and port 114. Those skilled in the art would recognize that pump 110 can use any type of pumping mechanism that can create two output streams of coolant.

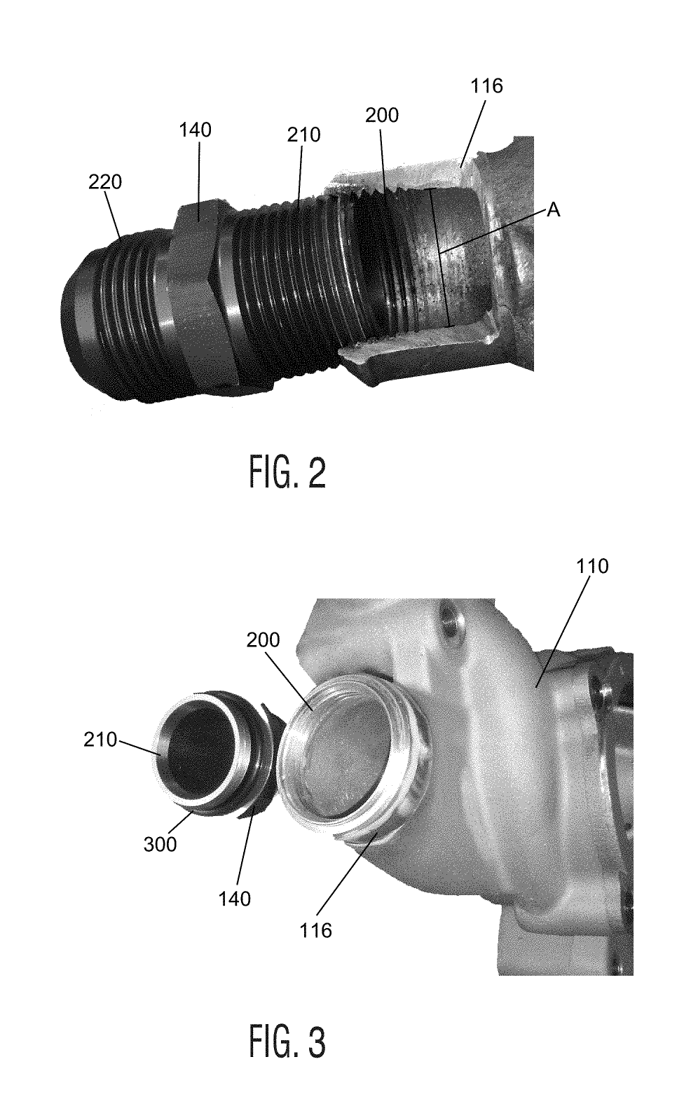

Ports 112, 114, and 116 each are threaded such that they each can act as a female coupler, meaning that each of them is configured to accept a threaded male adapter. A cut away section of port 116 in FIG. 2 shows the threading 200 on the inside surface of port 116. Threading 200 is emblematic of the threading present in ports 112 and 114. In one aspect, threading 200 has a thread size of −16 AN or −20 AN. These thread sizes allow compatibility with most commercially available parts. In another aspect, threading 200 is configured in a manner similar to national thread taper (NPT) threading, which allows a fluid-tight seal without using thread sealant. This prevents thread sealant from mixing with the coolant and damaging other parts of the engine.

Ports 112, 114, and 116 each have an inner diameter A between three-quarters of an inch and two inches. One skilled in the art would recognize that these sizes optimize coolant flow while maintaining compatibility with commercially available parts. One skilled in the art would also recognize that slightly larger and slightly smaller sizes would also be operable.

### Adapters

Returning to FIG. 1, apparatus 100 is shown as including three male adapters: 120, 130, and 140. Each adapter is configured such that one side of the adapter can be screwed into one of the outlet or inlet ports. Adapter 120 screws into port 112, adapter 130 screws into port 114, and adapter 140 screws into port 116.

Adapter 140 is shown in FIG. 2. The cutout portion of port 116 displays that adapter 140 has two opposing threaded portions 210 and 220. Portion 210 is threaded in such a manner as to allow it to couple with threading 200. Portion 220 is threaded and configured such that it can be screwed into a female coupler on a hose. In one aspect, the threading on portions 210 and 220 have a thread size of −16 AN or −20 AN. Once again, these thread sizes allow compatibility with most commercially available parts. In another aspect, the threading on portions 210 and 220 are configured in a manner similar to national thread taper (NPT) threading, which allows a fluid-tight seal without using thread sealant. As shown in FIG. 3, adapter 140 can include an O-ring 300 in order to improve the fluid-tight seal.

The configuration of adapter 140 is emblematic of that of adapters 120 and 130.

Adapters 120, 130, and 140 can be composed of any non-corroding, resilient material such as stainless steel.

### Hoses

Once again, returning to FIG. 1, apparatus 100 is shown as including three hoses: 150, 160, and 170. Each hose includes a female threaded coupler. Hose 150 includes coupler 122, hose 160 includes coupler 124, and hose 170 includes coupler 126. Coupler 122 connects to adapter 120, coupler 124 connects to adapter 130, and coupler 126 connects to adapter 140.

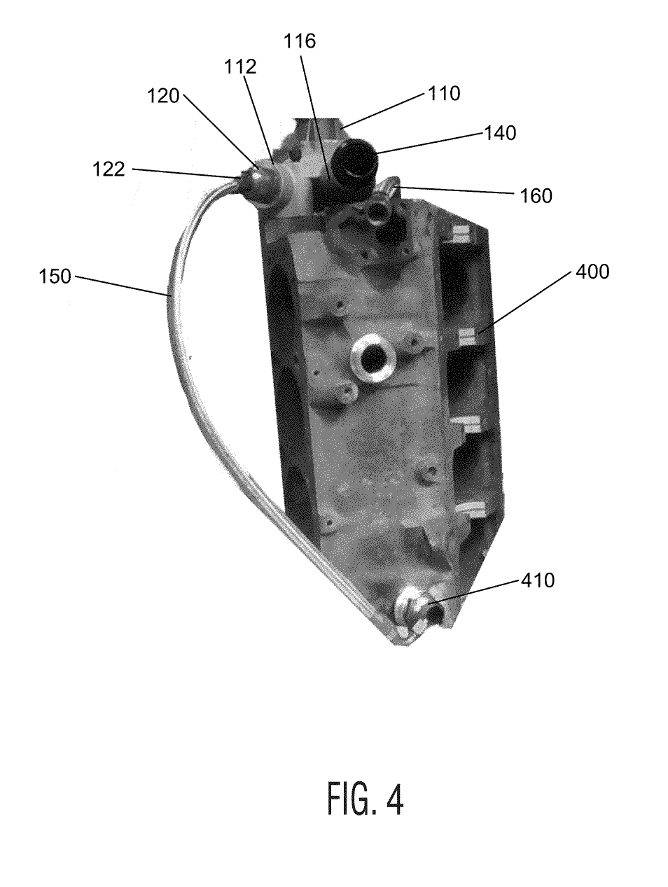

FIG. 4 shows how hose 150 connects pump 110 to an engine block 400 through a coolant intake port 410 on that engine block 400. Though pictured in FIG. 4, hose 160 is not shown in its proper configuration. Instead, hose 160 should connect to another coolant intake port (not shown in FIG. 4) on the opposite side of engine block 400. In addition, hose 170 connects pump 110 to a coolant reservoir or radiator (not shown in FIG. 4).

In one aspect, hoses 150, 160, and 170 are composed of braided stainless steel. This minimizes hose degradation and leakage over time. One skilled in the art would recognize that hoses 150, 160, and 170 could be composed of any similarly non-corroding, resilient material.

### Without Adapters

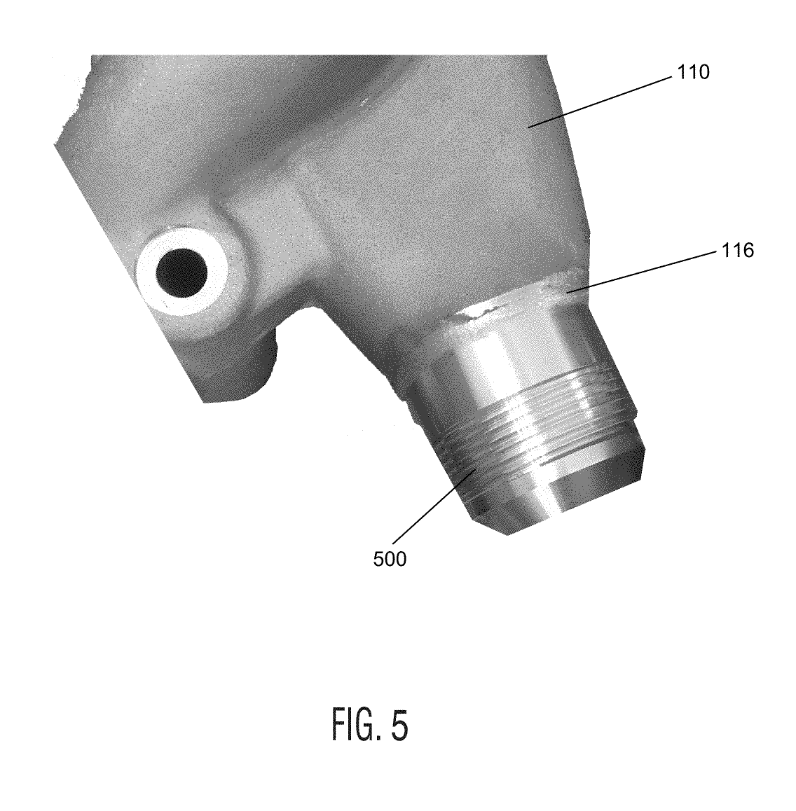

In another embodiment, a portion of which is shown in FIG. 5, apparatus 100 does not include adapters 120, 130, and 140. Instead, ports 112, 114, and 116 each include male threaded connectors. As displayed in FIG. 5, the outer surface of the end of port 116 includes threading 500. Threading 500 is configured such that port 116 can act as a male threaded connector that screws into coupler 126.

The configuration of port 116 in this embodiment is emblematic of the configuration of ports 112 and 114.

### Single Outlet Port

In another embodiment, not pictured, apparatus 100 only includes one outlet port. This means that pump 110 only includes ports 112 and 116. In this embodiment pump 110 does not have a twin volute housing, because the stream of coolant is not split by pump 110. In this embodiment, distribution of coolant through engine block 400 would be handled by a separate system not disclosed herein.

### Operation

Apparatus 100 pumps coolant fluid though an internal combustion engine. Hose 170 connects to port 140 which allows coolant to flow from either a radiator or a coolant reservoir into pump 110.

Once in pump 110, pump 110's twin volute housing splits the stream of coolant into two streams. One of those streams exits out of port 112, through hose 150 and into one side of engine block 400. The other stream exits out of port 114, through hose 160 and into the opposing side of engine block 400.

By distributing coolant to both sides of engine block 400, apparatus 100 allows for even cooling across the entirety of engine block 400. This is especially important in high performance engines where uneven cooling can allow for the creation of hot spots that damage the engine.

Traditional coolant distribution apparatuses use a clamp connector system instead of the threaded connectors described above. Clamp connecters limit vehicle owners to just using rubber hoses for transporting coolant through the engine. Rubber hoses, however, are prone to leaking after degrading in the heat produced by the engine. In order to maintain a proper seal with a clamp, rubber hoses are also limited in the size of their inner diameter.

A threaded connecter system, like the one described above, on the other hand. Allows vehicle owners to use stainless steel braided hoses, which are far more resilient than rubber hoses. Also, because threaded connectors do not depend upon the outside pressure of a clamp to create a seal, threaded connectors allow for hoses of widely varying size including hoses with a large inner diameter. Increasing the size of the hose can allow more coolant to flow through the engine, which causes the engine to cool down more quickly.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

1. An apparatus for circulating coolant in a combustion engine comprising:
a coolant pump, including a first outlet port with a first inner surface, a second outlet port with a second inner surface, and an inlet port with a third inner surface,
wherein the first, second, and third inner surfaces are threaded and configured to each act as a threaded female coupler;
a first hose with a first female coupler attached at a distal end, a second hose with a second female coupler attached at a distal end, and a third hose with a third female coupler attached at a distal end; and
a first tubular adapter with a first end with a first outer surface and a second end opposite the first end with a second outer surface, a second tubular adapter with a third end with a third outer surface and a fourth end opposite the third end with a fourth outer surface, and a third tubular adapter with a fifth end with a fifth outer surface and a sixth end opposite the fifth end with a sixth outer surface;
wherein the first outer surface is threaded and configured to couple with the first inner surface, the second outer surface is threaded and configured to couple with the first female coupler, the third outer surface is threaded and configured to couple with the second inner surface, the fourth outer surface is threaded and configured to couple with the second female coupler, the fifth outer surface is threaded and configured to couple with the third inner surface, and the sixth outer surface is threaded and configured to couple with the third female coupler.

2. The apparatus of claim 1, wherein the threads of each threaded surface have a size of −16 AN.

3. The apparatus of claim 1, wherein the threads of each threaded surface have a size of −20 AN.

4. The apparatus of claim 1, wherein the threads of each threaded surface are configured to form a standard pipe taper.

5. The apparatus of claim 1, wherein each hose is composed of braided stainless steel.

6. The apparatus of claim 1, wherein the first outlet, the second outlet, and the inlet each have an inner diameter between three-quarters of an inch and two inches.

7. An apparatus for circulating coolant in a combustion engine comprising:
a coolant pump, including a first outlet port with a first outer surface, a second outlet port with a second outer surface, and an inlet port with a third outer surface,
wherein the first, second, and third surfaces are thread and configured to act as a threaded male coupler;
a first hose with a first female coupler attached at a distal end, a second hose with a second female coupler attached at a distal end, and a third hose with a third female coupler attached at a distal end; and
wherein the first outer surface is configured to couple with the first female coupler, the second outer surface is configured to couple with the second female coupler, the third outer surface is configured to couple with the third female coupler.

8. The apparatus of claim 7, wherein the threads of each threaded surface have a size of −16 AN.

9. The apparatus of claim 7, wherein the threads of each threaded surface have a size of −20 AN.

10. The apparatus of claim 7, wherein the threads of each threaded surface are configured to form a standard pipe taper.

11. The apparatus of claim 7, wherein each hose is composed of braided stainless steel.

12. The apparatus of claim 7, wherein the first outlet, the second outlet, and the inlet each have an inner diameter between three-quarters of an inch and two inches.

13. An apparatus for circulating coolant in a combustion engine comprising:
a coolant pump, including an outlet port with a first inner surface, and an inlet port with a second inner surface,
wherein the first and second inner surfaces are threaded and configured to each act as a threaded female coupler;
a first hose with a first female coupler attached at a distal end, and a second hose with a second female coupler attached at a distal end; and
a first tubular adapter with a first end with a first outer surface and a second end opposite the first end with a second outer surface, and a second tubular adapter with a third end with a third outer surface and a fourth end opposite the third end with a fourth outer surface;
wherein the first outer surface is threaded and configured to couple with the first inner surface, the second outer surface is threaded and configured to couple with the first female coupler, the third outer surface is threaded and configured to couple with the second inner surface, and the fourth outer surface is threaded and configured to couple with the second female coupler.

14. The apparatus of claim 13, wherein the threads of each threaded surface have a size of −16 AN.

15. The apparatus of claim 13, wherein the threads of each threaded surface have a size of −20 AN.

16. The apparatus of claim 13, wherein the threads of each threaded surface are configured to form a standard pipe taper.

17. The apparatus of claim 13, wherein each hose is composed of braided stainless steel.

18. The apparatus of claim 13, wherein the first outlet, the second outlet, and the inlet each have an inner diameter between three-quarters of an inch and two inches.
